(19) United States
(12) Patent Application Publication
(10) Pub. No.: US 2026/0099690 A1
(43) Pub. Date: Apr. 9, 2026

(54) Interactive Information Card

(71) Applicant: Bret MAGPIONG, Redondo Beach, CA (US)

(72) Inventor: Bret MAGPIONG, Redondo Beach, CA (US)

(21) Appl. No.: 19/350,862

(22) Filed: Oct. 6, 2025

Related U.S. Application Data
(60) Provisional application No. 63/704,454, filed on Oct. 7, 2024.

(51) Int. Cl. G06K 19/06

(52) U.S. Cl. CPC G06K 19/06037

(57) ABSTRACT

An interactive card is described herein that may include a plurality of information zones including information hidden behind a plurality of removable elements. In some examples, the hidden information behind each of the plurality of removable elements may be configured, or otherwise designed, to elicit a spoken user response, such as by providing a question or verbal action. In some examples, the interactive card may further include an electronic engagement zone providing an electronic link to digital content that is related to the hidden information beneath each of the plurality of removable elements.

### RELATED APPLICATIONS

This application claims the benefit of and priority to U.S. Provisional Application Serial No.: 63/704,454, filed on Oct. 7, 2024, and entitled INTERACTIVE PULL TAB INFORMATION CARD, which is hereby incorporated herein by reference in its entirety.

### BACKGROUND

Various interactive card products exist in the market, including scratch-off cards and flip-cards. Such interactive cards aim to leverage the psychological reward system associated with discovery and the revelation of hidden information.

### SUMMARY

The present specification is generally directed to interactive cards and methods of use thereof.

In some aspects, the techniques described herein relate to an interactive card including: a plurality of information zones each including textual information; a plurality of removable elements disposed over the plurality of information zones, wherein each of the plurality of removable elements are configured to conceal one information zone of the plurality of information zones; an instruction zone including a set of text-based user instructions.

In some aspects, the techniques described herein relate to an interactive card, further including an electronic engagement zone including a quick release code configured to provide a link to digital content related to the interactive card.

In some aspects, the techniques described herein relate to an interactive card, wherein each of the plurality of removable elements includes a pull-tab.

In some aspects, the techniques described herein relate to an interactive card, wherein each the plurality of information zones and each of the plurality of removable elements are located on a first side of the interactive card, and wherein the instruction zone and the electronic engagement zone are located on a second side of the interactive card.

In some aspects, the techniques described herein relate to an interactive card, wherein the textual information of each of the plurality of information zones includes a question designed to elicit a spoken response from a user.

In some aspects, the techniques described herein relate to an interactive card, wherein the first side of the interactive card includes a category label configured to convey a category for the interactive card, and wherein the question is related to the category for the interactive card.

In some aspects, the techniques described herein relate to an interactive card, wherein the first side of the interactive card further includes a subcategory label configured to convey a sub-category for the interactive card.

In some aspects, the techniques described herein relate to an interactive card, wherein the plurality of information zones includes at least six information zones, and wherein the plurality of removable elements includes at least six shielding elements.

In some aspects, the techniques described herein relate to an interactive card, wherein the interactive card is made from a fibrous material.

In some aspects, the techniques described herein relate to an interactive card, wherein the plurality of information zones are printed on a first material layer and the plurality of removable elements includes a portion of a second material layer that is bonded to and entirely overlaps the first material layer.

In some aspects, the techniques described herein relate to a method of using an interactive card, the method including: obtaining the interactive card; removing a shielding element from the interactive card to reveal textual information configured to elicit a spoken user response; vocalizing an audible response to the textual information; and scanning a quick response code disposed on the interactive card with a mobile device to access digital content related to the interactive card.

In some aspects, the techniques described herein relate to a method, wherein removing the shielding element includes viewing a front surface of the interactive card, and wherein scanning the quick response code includes viewing a back surface of the interactive card.

In some aspects, the techniques described herein relate to a method, wherein viewing the back surface of the interactive card further includes reading a set of user instructions for the interactive card.

In some aspects, the techniques described herein relate to a method, wherein removing the shielding element includes pulling a pull-tab.

In some aspects, the techniques described herein relate to a method, wherein the textual information designed to elicit a spoken user response includes a question related to a category of the interactive card.

In some aspects, the techniques described herein relate to a method, wherein the method includes removing a plurality of additional shielding elements from the interactive card to reveal a plurality of additional questions related to the category of the interactive card.

In some aspects, the techniques described herein relate to a method, wherein obtaining the interactive card includes selecting the interactive card from a plurality of interactive cards each having the same category of the interactive card.

In some aspects, the techniques described herein relate to a method of manufacturing an interactive card, the method including: disposing a plurality of questions configured to elicit a spoken user response about a first side of a base of the interactive card; disposing a set of user instructions about a second side of the base; disposing a quick response code about the second side of the base; disposing a plurality of removable shielding elements about the first side of the base to conceal a plurality of questions designed to elicit a spoken user response; disposing a category label configured to convey a category of the interactive card about the first side of the base; and disposing a subcategory label configured to convey a subcategory of the interactive card about the first side of the base.

In some aspects, the techniques described herein relate to a method, wherein disposing the plurality of questions, the quick response code, and the set of user instructions about the second side of the base includes printing the plurality of questions, the quick response code, and the set of user instructions directly on an outer surface of the base.

In some aspects, the techniques described herein relate to a method, disposing a plurality of questions configured to elicit a spoken user response about the first side of the base includes printing the plurality of questions on a front surface of the base; and wherein disposing the plurality of removable shielding elements about the first side of the base includes adhering a material layer over an entire front surface of the base.

### BRIEF DESCRIPTION OF THE DRAWINGS

The following figures are included to illustrate certain example aspects of the present disclosure and should not be viewed as exclusive or limiting. The subject matter disclosed is capable of considerable modifications, alterations, combinations, and equivalents in form and function, as will occur to one having ordinary skill in the art and having the benefit of this disclosure. Reference is being made to the accompanying drawings, in which:

FIG. 1 illustrates a first side of an interactive card including a plurality of shielding elements, in accordance with one example of the present disclosure.

FIG. 2 illustrates the interactive card of FIG. 1 with the plurality of shielding elements removed, in accordance with one example of the present disclosure.

FIG. 3 illustrates a second side of the interactive card of FIGS. 1-2, in accordance with one example of the present disclosure.

FIG. 4 illustrates a first side of an interactive card, according to one example of the present disclosure

FIG. 5 illustrates a second side of the interactive card of FIG. 4, according to one example of the present disclosure.

FIG. 6 illustrates a method of using an interactive card, according to one example of the present disclosure.

### DETAILED DESCRIPTION

It will be appreciated by persons skilled in the art that the present disclosure is not limited to what has been particularly shown and described herein. A variety of modifications and variations are possible in view of the teachings herein without departing their scope, spirit, or intent.

While different examples may be described in this specification, it is specifically contemplated that any of the features from the different examples may be used and brought together in any combination. In other words, the features of different examples may be mixed and matched with each other. Hence, while every permutation of features from different examples may not be explicitly shown or described, it is the intention of this disclosure to cover any such combinations, especially as may be appreciated by one of skill in the art.

The terminology used in this disclosure should be interpreted in a permissive manner and is not intended to be limiting. In the drawings, like numbers refer to like elements. Unless otherwise noted, the accompanying drawings are not to scale.

As previously noted above, interactive cards such as scratch-off or flip cards are in use in market areas such as the gambling industry, at least because it is known that the human brain releases dopamine during the revelation of hidden information and/or during tactile (i.e. touch) engagement. However, existing interactive cards do little to foster structured conversation, or other types of meaningful engagement, between multiple people. Moreover, existing interactive cards may not include digital integration to further capitalize on innate human curiosity and/or the desire to discover. Thus, there is a need for at least a more engaging and versatile interactive card product that combines tactile engagement with structured verbal interactions and digital integration.

To help address this issue, the present disclosure includes an interactive card including a plurality of removable elements to provide physical or tactile user engagement with the interactive card, each of which reveal hidden information to the user when removed or opened. In some examples, the hidden information behind each of the plurality of removable elements may be configured, or otherwise designed, to elicit a spoken user response, such as by providing a question or verbal action prompt, to help provide or establish meaningful conversational engagement between two or more users and/or the interactive card. In some examples, the interactive card may further include an electronic engagement zone to help establish additional and digital user interaction, such as between the interactive card and/or one another, by providing an electronic link to digital content that is related to the hidden information beneath each of the plurality of removable elements.

Thus, it may be readily appreciated that the interactive card of the present disclosure may help to facilitate, or help to create, a shared interactive process of discovery and/or a shared process of revealing hidden information, and as such, may, in turn, help to provide opportunities for meaningful social discussion or collaborative learning, and/or may help to facilitate a meaningful exchange of ideas or obtain multiple perspectives that may enhance or establish mutual understanding between users. Therefore, the interactive card may be desirable in, for example, but not limited to, social settings including group introduction events (e.g., icebreaking or first-time meetings), personal or professional team-building situations, social evenings or other social events, educational courses, therapy sessions, or dating or personal relationship-seeking events, among others.

In summary, the interactive card disclosed herein may leverage numerous powerful psychological phenomena (e.g., physical engagement, verbal engagement, and/or digital interaction), such as providing a uniquely engaging and effective tool for use in fostering meaningful interpersonal face-face interactions and/or improving personal growth. Moreover, it is also appreciated that by leveraging such psychological phenomena, the interactive card disclosed herein may also be desirable in other (e.g., non-social) settings, such as in the development or creation of marketing, promotional, and/or advertising materials that seek or otherwise prize enhanced user engagement to thereby provide memorable and more effective content.

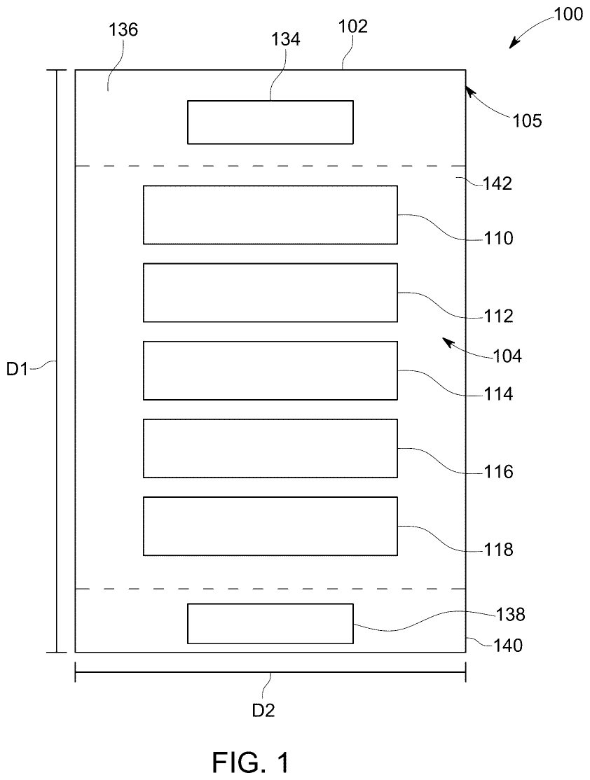

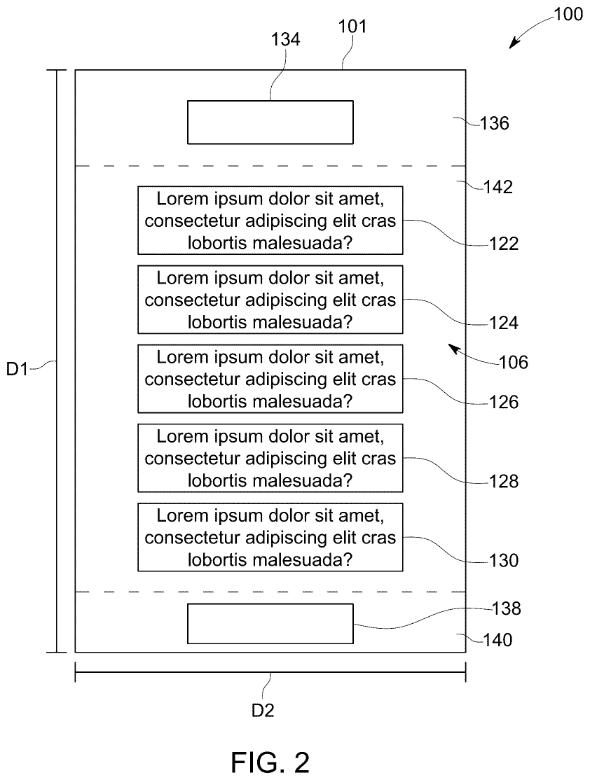

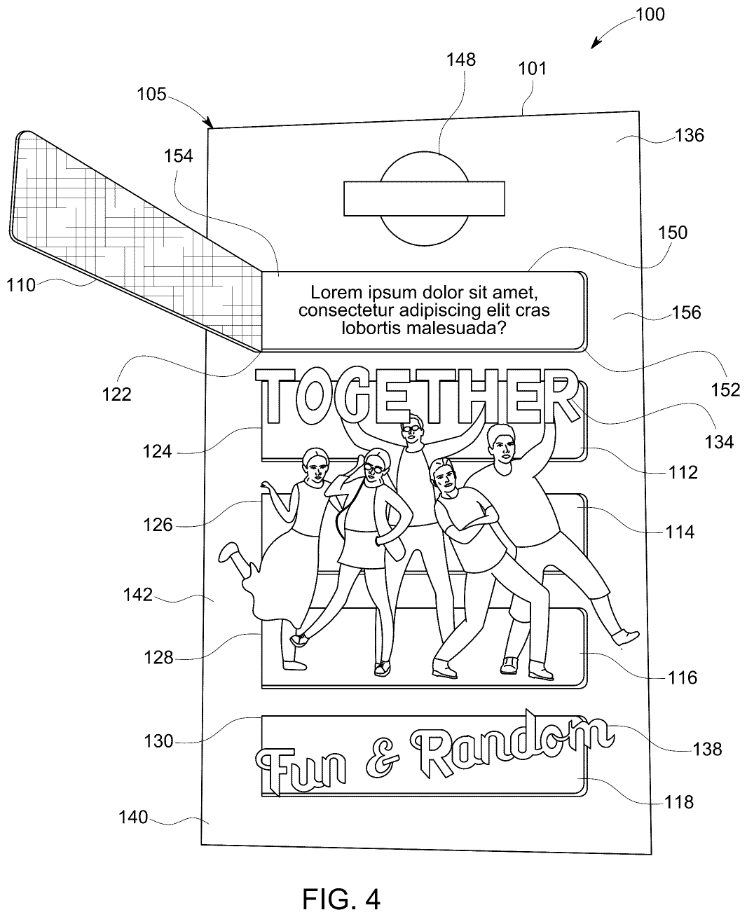

FIG. 1 illustrates a first side 101 of an interactive card 100 including a plurality of removable elements 104, in accordance with one example of the present disclosure. FIG. 2 illustrates the interactive card 100 of FIG. 1 with the plurality of removable elements removed 104 to reveal a plurality of information zones 106, in accordance with one example of the present disclosure. FIG. 4 also illustrates the first side 101 of the interactive card 100, according to one example of the present application. FIGS. 1-2 and 4 are discussed below concurrently. The interactive card 100 may include a base 105 about which the plurality of removable elements 104 and the plurality of information zones 106 may be disposed, arranged, and/or otherwise distributed.

The first side 101 (i.e. a front or upper side) of the base 105 may represent, or may comprise, one or more material layers of the interactive card 100. In some examples, each of the plurality of removable elements 104 may be arranged on or about the first side 101 of the base 105. In other examples, one or more of the plurality of removable elements 104 may be arranged on or about the second side 102. Each of the plurality of removable elements 104 may be a structure that is adapted to obscure, conceal, hide, or otherwise shield the plurality of information zones 106 from a user's view. For example, each of the plurality of removable elements 104 may be made from an opaque material, and may be at least the size of, if not larger than, each of the plurality of information zones 106.

In some examples, the plurality of removable elements 104 may be peel-off or pull-off pull-tabs that are attached on or about the front side of the base 105. In other examples, the plurality of removable elements 104 may be tear-off or pull-off tabs comprising perforated, scored, or otherwise weakened sections of a material layer of the first side 101. In any such example, the plurality of removable elements 104 may be adapted or configured to be relatively easily removable by a user but also secure enough to prevent accidental removal or dislodgement from the base 105.

In view of the above, a user may physically interact or engage with the interactive card 100 by removing, such as by grasping and/or pulling, the plurality of removable elements 104 away from the base 105 or otherwise pivoting the plurality of removable elements 104 with respect to the base 105 such that the plurality of information zones 106 become visible to the user. More specifically, in some examples, each of the plurality of removable elements 104 may be entirely removed from the base 105 to reveal the plurality of information zones 106, such as shown in FIG. 2, or only partially removed (e.g., pivoted or bent away) from the base 105, such as shown in FIG. 4, to reveal the plurality of information zones 106 there beneath.

In further examples, each of the plurality of removable elements 104 may include a number to suggest to user a specific order in which the plurality of removable elements 104 should be engaged and/or removed. Additionally, in still further examples, the plurality of removable elements 104 may also include a label element which may include any information pertaining to a theme, category, subcategory, and/or use case, of the interactive card 100, such as a textual label, a picture, a drawing, or symbol. In this regard, more specific examples of information that the plurality of removable elements 104 may include are discussed further below.

The plurality of removable elements 104 may include various numbers of individual removable elements. In some examples, such as shown in FIG. 1, the plurality of removable elements 104 may include a first removable element 110, a second removable element 112, a third removable element 114, a fourth removable element 116, and a fifth removable element 118. However, in other examples, the plurality of removable elements may include other numbers of individual removable elements, such as, but not limited to, one, two, three, four, seven, eight, nine, or ten removable elements. In another specific example, the plurality of removable elements 104 may include six removable elements.

The plurality of removable elements 104 may also be arranged about the base 105 in various orientations or configurations. In some examples, such as shown in FIGS. 2 and 4, the plurality of removable elements 104 may be centered, or laterally aligned on the interactive card 100, with respect to one another, and may be spaced equidistantly apart from one another in a vertical direction (e.g., with respect to a first dimension D1). However, in other examples, the plurality of removable elements 104 may be laterally offset, or staggered, with respect to one another, and/or may be spaced non-equidistantly apart from one another in a vertical direction. Additionally, the plurality of plurality of removable elements 104 may be similar in size or shape relative to another or may be different in size and shape relative to another, such as depending upon the quantity of information or text that each of the plurality of information zones 106 are configured to contain.

Turning now to the plurality of information zones 106, each of the plurality of information zones 106 may be a separate location which contains information, such as, but not limited to, text (e.g., numerical or textual information), or otherwise related, to a theme, category, or use case of the interactive card 100. In this regard, the plurality of information zones 106 are shown as including exemplary “lorem ipsum” scrambled text that is not intended to convey any meaning other than to represent textual information. In some examples, each of the plurality of information zones 106 may include information designed to elicit a spoken user response. More specifically, the written information within each of the plurality of information zones 106 may be a question or a verbal action prompt for a user to answer or otherwise response to, such as with an opinion and/or thought(s), out loud so that other people or users may listen.

Generally, such questions and/or verbal action prompts may be representative of a diverse spectrum spanning from relatively easy to answer or casual to more thought-provoking, personal, challenging, emotional, philosophical, vulnerable, and/or deep, depending upon the theme, category, subcategory, or use case of the interactive card 100. As a non-limiting example, by way of illustration, some questions may be light and whimsical digging into individual preferences and habits, such as “How do you prefer your coffee-strong, mild, or somewhere in between, and why?”, while others might touch on how a user handles an unexpected or challenging social situation, such as “How do you react when someone cuts you off in traffic?”, while still others may challenge a user's understanding of existence and the nature of reality, such as “What do you believe is the source of human creativity and inspiration?”

In some examples, one or more the plurality of information zones 106 may alternatively include facts or statistics related to the theme, category, or intended use case of the interactive card 100. In still further examples, one or more information zones of the plurality of information zones 106 may include physical action prompts intended to convey what physical actions and/or next steps a user should take.

The number of individual information zones that the plurality of information zones 106 may include may be equal to the number of removable elements that the plurality of removable elements 104 includes, or vice versa. As one such example, the plurality of information zones 106 may include a first information zone 122, a second information zone 124, a third information zone 126, a fourth information 128, and a fifth information zone 130, to correspond to the first removable element 110, the second removable element 112, the third removable element 114, the fourth removable element 116, and the fifth removable element 118, respectively. In another specific example, the plurality of information zones 106 may include six information zones.

Additionally, because each of the plurality of removable elements 104 conceals (e.g., is sized and shaped, and positioned, to shield one of the plurality of information zones 106 from view), it may be appreciated that the plurality of information zones 106 are positioned, oriented, or arranged about the interactive card 100 in a similar fashion to the plurality of removable elements 104.

Finally, it is further appreciated that, at least because the plurality of information zones 106 may contain a plurality of different questions, action prompts, or other facts and/or information concealed beneath the plurality of removable elements 104, the interactive card 100 may help to eliminate, or at least reduce, the need to carry a relatively large number of cards, such as to help start and/or maintain a conversation or communal user engagement. For example, relative to a traditional game card or playing card where all information is revealed upon the card being turned over by user, the interactive card 100 of the present disclosure may slowly reveal varied information through repeated user engagement with the same card.

In some examples, the first side 101 of the interactive card 100 may further include a first label element 134. The first label element 134 may be configured to convey to a user, or otherwise characterize the interactive card 100 by, a particular theme, category, or an intended use to which the information contained in the plurality of information zones 106 pertains to or is otherwise relevant to. In this regard, the first label element 134 may represent any combination of textual information, numerical symbolic information, or one or more pictorial depictions or photographic images, intended to help describe or otherwise capture the display, in an easily recognizable way, the theme, category, or intended use case for the interactive card 100. Several more specific examples of information which the first label element 134 may contain are discussed further below.

In some examples, the first side 101 of the interactive card 100 may further include a second label element 138. In some examples, the second label element 138 may be configured to convey to a user a subtheme or a subcategory of the interactive card 100, such as more narrowly defined or more narrowly characterizing the information contained in the first label element 134. In some examples, the second label element 138 may simply convey further information or description about the theme, category, or use case of the interactive card 100. In this regard, the second label element 138 may represent any combination of textual information or written language, one or more symbols, or one or more pictorial depictions or photographic images. Several more specific examples of information which the second label element 138 may contain are discussed further below.

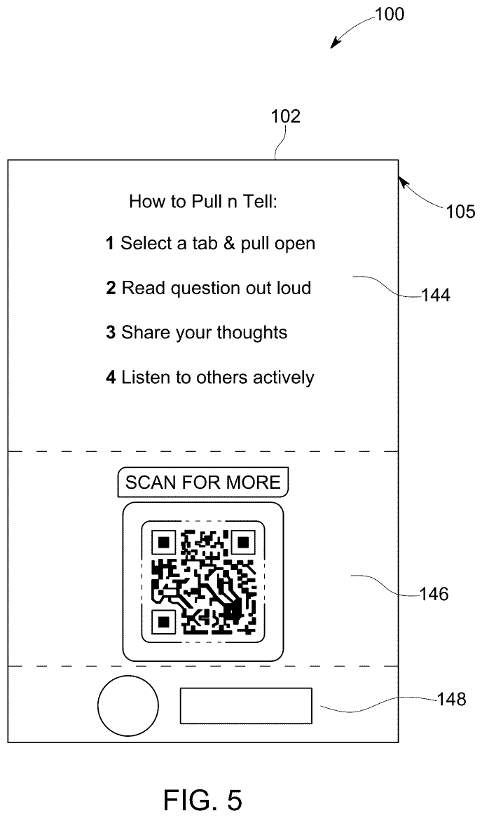

In some examples, such as shown in FIGS. 1-2, the first label element 134 may be in an upper region 136 of the first side 101 and the second label element 138 may be in a lower region 140 of the first side 101. In other examples, the first label element 134 may be in the lower region 140 of the first side 101 and the second label element 138 may be in the upper region 136 of the first side 101. In further examples, such as shown in FIG. 5, the first label element 134 may be at least partially positioned in a middle region 142 of the first side 101. In this regard, the first label element 134, such as shown in FIG. 5, may span, or otherwise be large enough to cover, a substantial portion of the middle region 142 including any and/or all the plurality of removable elements 104.

In some examples, the second label element 138 may also comprise a plurality of additional labeling elements beyond the first label element 134, such as by including one second label element including further information about the theme, category, or use case of the interactive card 100 and another second label element setting out a series number (i.e. 1 of 3, or 2/3, card 3 of 3 etc.) of the interactive card 100, such as in an example where the interactive card is part of a plurality of cards each having the same theme, category, or use case but each including different information in the plurality of information zones 106. In some such examples, it is appreciated that the interactive card 100 may be supplied in a plurality, pack, bundle, or group of cards contained, for example, but not limited to, within an inclusive range of about 2 cards and about 10 individual cards.

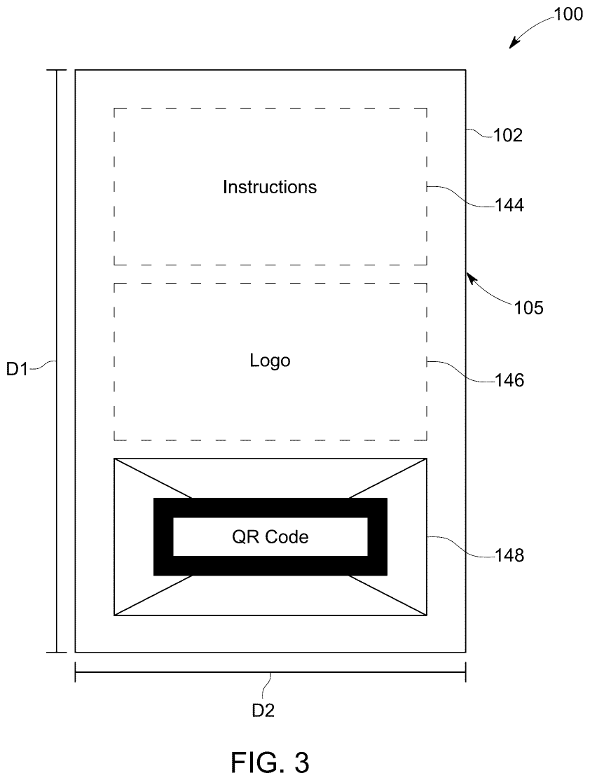

FIG. 3 illustrates a second side 102 of base 105 of the interactive card 100, according to one example of the present application. FIG. 5 also illustrates the second side 102 of the interactive card 100, according to one example of the present application. FIGS. 3 and 5 are discussed below concurrently. The second side 102 (e.g., a back side) of the base 105, like the first side 101, may represent or comprise one or more material layers of the interactive card 100. In some examples, the second side 102 may include an instruction zone 144 and an electronic engagement zone 146. However, in other examples, the instruction zone 144 and/or the electronic engagement zone 146 may also be located about the first side 101 and one or more of the plurality of information zones 106 and the plurality of removable elements 104 may be located about the second side 102.

In some examples, the instruction zone 144 may include or comprise any information, such as including textual information, numerical information, and/or symbol(s) configured to help a user understand how the interactive card 100 is intended to be used. For example, the instruction zone 144 may include an ordered list setting out step-by-step instructions for physical use or operation of the interactive card 100. In other examples, the instruction zone 144 may also, or may alternatively, include any information, such as including textual information, numerical information, and/or symbol(s) configured to help perform further actions related to the theme, category, or use case of the interactive card 100 but not directly related to physical operation of the interactive card 100 itself.

Thus, the content of the instruction zone 144 may vary widely. In one example, such as shown in FIG. 5, such as in example where the theme, category, or use case of the interactive card 100 is related to social interaction between two or more users, such a set of instructions may recite a heading reciting “How to Pull n Tell”, with the following steps set out in an ordered fashion there beneath: (1) “Select a Tab and Pull Open”, (2) “Read Question Out Loud” or “Read Prompt Out Loud, (3) “Share Your Thoughts”, and (4) “Listen to Others Actively”. Additional non-limiting examples of information which the instruction zone 144 may contain are discussed further below with references to specific themes, categories, and/or use case of the interactive card 100.

The electronic engagement zone 146 may be an area or region of the interactive card 100 that is configured to enable a user to access digital, content related to the theme, category, and/or use case of the interactive card 100. For example, the electronic engagement zone 146 may include a Quick Response (“QR”) code (i.e. a 2D barcode that may store digital access information, such as a Uniform Resource Locator (“URL”) to link to a website or a mobile device application, that may be easily read by cameras on mobile devices including smartphones and/or tablets). In other words, the electronic engagement zone 146 may provide a digital link to facilitate additional user engagement with interactive card 100 beyond the plurality of information zones 106 and the plurality of removable elements 104.

In some examples, the electronic engagement zone 146 may be configured to guide a user to a customized, or otherwise tailored, web page and/or mobile application that provides additional context, suggested answers, more detailed information, more questions and/or verbal prompts, among other information, and/or interactive elements, pictures, or videos that complement the information contained in the interactive card 100. In this respect, it is also appreciated that such digital integration may allow, beyond additional or expanded content, for the ability to update information that is electronically linked to the card without changing the interactive card 100 itself.

In some examples, the electronic engagement zone 146 may further include information disposed on the interactive card 100 that is designed or configured to encourage a user to utilize the electronic engagement zone 146 to thereby engage with additional content. For example, such as shown in FIG. 5, such information may include a written phrase such as, but not limited to, “Scan for More” or “Scan to Continue Conversation”among other phrases.

In some examples, the interactive card 100 may include a logo element 148. In some examples, the logo element 148 may be a standalone element that is separate from first label element 134 or the second label element 138. In some such examples, the logo element 148 may be an emblem or logo associated with the maker of the interactive card 100, or an emblem or logo associated with a business or organization that the interactive card 100 is configured or customized for, to be used by employees or clients of, and/or to advertise or promote. However, in other examples, it is to be appreciated that the logo element 148 may simply be one area or feature of the first label element 134 or the second label element 138.

In some examples, the logo element 148 may be in a middle or medial region or zone of the second side 102 between the instruction zone 144 and the electronic engagement zone 146. In other examples, the logo element 148, or additional logo elements, may be in other locations about the interactive card 100, such as in the upper region 136 as shown in FIG. 4, the lower region 140 as shown in FIG. 5, or the middle region 142 on the first side 101. Alternatively, the logo element 148 may be located above or below the instruction zone 144 or the electronic engagement zone 146 on the second side 102. In any such example, the logo element 148 may be centered within, or may laterally offset (relative to the second dimension D2) from a center point of the interactive card 100.

In some specific examples, the logo element 148 may include a descriptive heading or label eluding the intended use case of the interactive card 100. In some such examples, the logo element 148 may recite “Pull n Tell”, “Pull n Engage”, or “Pull n Feel” in examples where the plurality of information zones 106 include questions and/or verbal prompts, “Pull n Learn” in examples where the plurality of information zones 106 include facts and/or term definitions related to education, or “Pull n Act” in examples where the plurality of information zones 106 include physical action prompts.

By way of providing context and non-limiting illustration, several examples of themes, categories, and/or use cases to which each of the plurality of information zones 106, the first label element 134, and/or the second label element 138 may pertain are described below. In a first example, the theme, category, or use case of the interactive card 100 may be, or may pertain to, dating or personal relationship-seeking settings. In some such examples, the first label element 134 may include a symbol or pictorial representation, such as heart symbol, a cupid symbol, a love knot symbol, a hand-holding symbol, or any other symbol, graphics, and/or imagery associated with love, intimate or romantic relationships, or intimacy or partnership.

In some such examples, the first label element 134 may alternatively, or additionally, include textual information such as, but not limited to, topical phrases or categories such as “Couples Edition” or “Date Night”, among other phrases associated with love, intimate relationships, or intimacy or partnerships. In some such examples, the second label element 138 may include an additional descriptive phrase, or a sub-topical or sub-categorical phrase, such as “Get Acquainted”, “First Date”, “Second Date”, or “Future Plans”, “Communication,” or “Intimacy”, among others. In some such examples, the second label element 138 may comprise, or may additionally include individual sub categorical label(s) on one and/or all the plurality of removable elements 104. As one example, three separate elements of the plurality of removable elements 104 may include or display the phrases “Future Plans”, “Communication,” or “Intimacy”, among other phrases.

In some such examples, each of the plurality of information zones 106 may include a different question or verbal action prompt within the theme, category, or use case of the interactive card 100 that is selected or otherwise designed to help structure and establish meaningful conversation or engagement between users. By way of example, some such questions may include “What's your favorite memory of us together?” or “How do you envision our relationship in five years?”, among a wide variety of others. In some such examples, the instruction zone 144 may comprise, or may further include, such as beyond an ordered list setting out step-by-step instructions for physical or digital use of the interactive card 100, a specific direction for a couple (i.e. a pair of users) to take turns removing the plurality of removable elements 104, and then responding to and/or answering, the various action prompts or questions, respectively, contained in the plurality of information zones 106.

In some examples, such instructions may also ask both users to respond to and/or answer each of the questions and/or verbal prompts in the plurality of information zones 106. In some such examples, the electronic engagement zone 146 may link, when scanned by a user's mobile device, to a mobile application or webpage that is adapted or customized for couple activities and/or dating purposes. In some such examples, the mobile application or webpage may include additional conversation starters or other questions, or further action prompts for relationship-building exercises, among other digital content.

In a second example, the theme, category, or use case of the interactive card 100 may be, or may pertain to, psychological and/or emotional therapy sessions or settings. In some such examples, the first label element 134 may include a symbolic or pictorial representation associated with calm, inner peace, serenity, therapy, or any other symbol adapted to convey a calming feeling or a calm state of mind, among other graphics that may be relevant to therapy. In some such examples, the first label element 134 may alternatively or additionally include, or the second label element 138 may instead include a topical or thematic phrase such as “Therapy Session Guide”, among other similar phrases designating that the interactive card 100 is configured or customized for use during a therapy session.

In some such examples, each of the plurality of information zones 106 may include a suitable question and/or verbal action prompt for therapy purposes, such as phrases like, but not limited to, “Describe a situation that made you anxious recently”, “What thoughts went through your mind?”, and/or “What's one small step you could take this week towards your goal?”, among a wide variety of others. In some such examples, the instruction zone 144 may comprise, or may further include, such as beyond an ordered list setting out step-by-step instructions for physical or digital use of the interactive card 100, one or more specific directions and/or information designed to help guide a therapy participant on how to utilize the interactive card 100 between sessions or what additional actions and/or steps to take between session.

In some such examples, the electronic engagement zone 146 may link, when scanned by a user's mobile device, to a mobile application, webpage, or secure patient portal adapted or customized for therapy or healthcare use. In some such examples, such a mobile application, webpage, or secure patient portal may include additional therapy resources, mood tracking tools, and/or homework assignments, among other information. In some such examples, the second label element 138 may comprise, or may additionally include individual sub categorical label(s) on one and/or all the plurality of removable elements 104, such as numbering two, three, four, five, or six, among other numbers, of different stages of a therapy session.

In a third example, the theme, category, or use case of the interactive card 100 may be, or may pertain to, marketing, promotional, or advertising materials for non-profit organizations and/or for-profit businesses. In some such examples, the first label element 134, and/or the logo element 148, may include the organization's emblem or logo or any other symbolic or graphical representation of the organization or company. In some such examples, the first label element 134 may additionally include, or the second label element 138 may instead include, a written cause, slogan, motto, tagline, catchphrase, or any other message the business or organization wishes to convey or otherwise be associated with.

In some such examples, the plurality of information zones 106 may each include any information adapted to convey facts, such as concise, impactful information pertaining to the organization or business. In some examples, such information may include, but is not limited to, a key statistic related to a mission of the organization, a brief success story related to the organization or business, a fact debunking a common misconception about a cause or goal of the organization or business, among a wide variety of other information. In some such examples, the second label element 138 may comprise, or may additionally include individual sub topical label(s) on one and/or all of the plurality of removable elements 104. As one example, three separate removable elements of the plurality of removable elements 104 may include the sub-topical or sub-categorical terms or phrases related to an organization's mission, such as, but not limited to, “Our Impact,” “Get Involved,” or “Quick Facts”, among other phrases.

In some such examples, the instruction zone 144 may comprise, or may further include, such as beyond an ordered list setting out step-by-step instructions for physical or digital use of the interactive card 100, instructions or encouragement for users to sharing any information on the interactive card 100 about the organization or business, or otherwise promote the organization or business, on social media. In some such examples, the electronic engagement zone 146 may direct, or otherwise link when scanned by a user's mobile device, to a mobile application or webpage customized for donations or volunteer sign-up purposes, or to a webpage of the organization or business.

In a fourth example, the theme, category, or use case of the interactive card 100 may be, or may pertain to, exercise, physical fitness, and/or physical training coaching. In some such examples, the first label element 134 may include a symbolic or pictorial representation associated with exercise, fitness, or coaching, among other symbols or graphics that may be relevant to physical training. In some such examples, the first label element 134 may alternatively or additionally include, or the second label element 138 may instead include a topical or thematic phrase such as “Your Personal Workout”. In some such examples, each of the plurality of information zones 106 may include a different question and/or physical action prompt that is designed to structure or organize a workout or exercise session.

In some such examples, each of the plurality of information zones 106 may include, but are not limited to, an exercise or activity for user to perform, such as, but not limited to, “Do 10 push-ups”, “Hold a plank position for 30 seconds”, or “Take a 5-minute brisk walk”, among others exercises or activities. In some such examples, the second label element 138 may comprise or may additionally include a sub topical or sub categorical element on one or more and/or all the plurality of removable elements 104. As one such example, five separate removable elements of the plurality of removable elements 104 may include the phrases “Warm-up,” “Cardio,” “Strength,” “Flexibility,”and “Cool-down”, among other terms or phrases.

In some examples, the instruction zone 144 may comprise, or may further include, such as beyond an ordered list setting out step-by-step instructions for physical or digital use or operation of the interactive card 100, directions to create a full workout, such as by combining exercises from different tabs in various ways. In some examples, the electronic engagement zone 146 may direct, or otherwise link when scanned by a user's mobile device, to a mobile application or webpage including instructional videos or other interactive content that helps to demonstrate or otherwise illustrates and/or explain the proper physical form, or other instructions, for performing each exercise set out in the plurality of information zones 106 or additional exercises set out in such a mobile application or webpage.

In a fifth example, the theme, category, or use case of the interactive card 100 may be, or may pertain to, personal learning, personal education, group learning, or group education. In some such examples, the first label element 134 may include a book, a classroom, a brain or mind graphic, a scroll, or any other symbol, graphic, or pictorial representation associated with learning and/or education. In such an example, the first label element 134 may further include, or may alternatively include textual information which may state or otherwise convey to a user a particular subject, category, or topic of education or learning to which the interactive card 100 may be directed to. In some such examples, the second label element 138 may include information pertaining to a subcategory or a subtopic, a specific learning objective, or may otherwise more narrowly define the subject, category, or topic of education or learning objection conveyed by the first label element 134.

In some such examples, the each of the plurality of information zones 106 may include information designed to help facilitate meaningful or productive learning outcomes, such as, but not limited to, a definition or explanation of an important term or word, a practice question, or a mnemonic device for remembering or memorizing crucial information, among a wide variety of other information. In some such examples, the electronic engagement zone 146 may direct, or otherwise link when scanned by a user's mobile device, to a mobile application or webpage providing instructions which help to guide students on how to use the interactive card 100 to self-test and/or practice for an exam or otherwise use the interactive card to learn new information. In some such examples, the electronic engagement zone 146 may direct, or otherwise link when scanned by a user's mobile device, to a mobile application or webpage customized to provide more comprehensive study materials or information, online quizzes, videos, lectures, or any other additional educational content relating to the theme, category, or use case of the interactive card 100.

In a sixth example, the theme, category, or use case of the interactive card 100 may be, or may pertain to, group introductions and/or team building. In some such examples, the first label element 134 may include a pictorial or graphical representation of a group setting, such as a plurality of chairs, a conference table or meeting room, a handshake, among other related imagery or symbols. In some such examples, the first label element 134 may additionally include, or may alternatively include, categorical, thematic, or otherwise descriptive information related to the use case of the interactive card 100, such as, but not limited to, “Get Together”, “Girls Night In”, “Group Meeting”, “Pizza Night”, “Family Time”, “Networking”, or “Team Building”, “Road Trip”, among a wide variety of others. In one such example, the second label element 138 may include sub categorical or otherwise more descriptive terms or phrase such as, but not limited to, “Lighthearted”, “Unwind”, “Icebreakers”, “Fun and Random”, “Common Ground”, respectively, among various other descriptive terminology.

In such examples, it is also further appreciated that the electronic engagement zone 146 may, when scanned by a user's mobile device, link to a mobile application or webpage that is customized to include relevant additional content such as, but not limited to, further conversation starters (e.g., questions), other types of questions, fun facts, or verbal and/or physical action prompts, to help facilitate and/or continue engagement between users. In view of at least the above examples, the interactive card 100 may be an effective tool in helping two or more users to break any social tension and/or silence therebetween, and further help to establish meaningful and non-trivial face to face conversations to bring users closer together.

In various examples, the interactive card 100 may be constructed from one, or a variety, of materials. In some examples, the base 105 may be constructed from one or more layers of fibrous material, such as relatively heavyweight paper, card stock, or cardboard, among other fibrous (e.g., paper-based) materials. In some examples, the interactive card 100 may be constructed from one or more layers of cardstock each within an inclusive range of about 70-pound cardstock to about 130-pound cardstock. Alternatively, and/or additionally, the base 105 may be constructed from one or more layers of a polymeric material (e.g., plastic), such as Vinyl (PVC), Polyester (“PET”), acrylonitrile butadiene styrene (“ABS”), polyvinyl chloride (“PVC”), Low-Density Polyethylene (“LDPE”), or polypropylene (“PP”), among other polymeric materials.

In some examples, the base 105 may be comprised of unitary material (e.g., unitary construction) on which all the content and/or information described above may be deposited, disposed, or otherwise arranged. In other examples, the base 105 may be comprised of multiple material layers (e.g., a layered construction) over, or throughout, which the content and/or information described above may be deposited, disposed, or otherwise arranged. In one such example, such as shown in FIG. 4, the base 105 may include a first material layer 150 (e.g., a base material layer) and a second material layer 152 bonded to the first material layer 150. In some examples, such as also shown in FIG. 4, the second material layer 152 may entirely overlap the first material layer 150 such that all perimeter or outer edges of the second material layer 152 are flush with perimeter or outer edges of the first material layer 150.

In some such examples, each of the plurality of removable elements 104 may comprise a portion of a second material layer 152 that is bonded to and entirely overlaps the first material layer 150. In one such example, the plurality of removable elements 104 may comprise tear-off pulls which are formed by perforating, scoring, or otherwise weakening the second material layer 152, such as between a first surface 154 in contact with the first material layer 150 and an opposite upper surface 156 (e.g., forming a front surface of the base 105) on which information such as the first label element 134, the second label element 138, and a logo or other information may be contained. In such an example, the plurality of information zones 106 may be deposited directly on the first material layer 150.

It is also appreciated that the interactive card 100 be manufactured in a method or process that employs or otherwise includes various production techniques. In some examples, any content and/or information located on the interactive card 100, may be disposed, deposited, or arranged using, for example, but not limited to, screen printed, reel-to-reel printing, dot matrix printing, laser printing, cylinder press printing, ink jet printing, flexographic printing, lithographic printing, offset printing, digital printing, gravure printing, or xerographic printing, among other techniques such as embossing or debossing.

In some examples, producing or otherwise forming one or more material layers of the base 105 may include die-cutting, laser-cutting, layered printing with registration, and/or layered production techniques such as, but not limited to, adhesive bonding, riveting, stitching, or binding. In some examples, that the interactive card 100 may, in some examples, be configured to be produced inexpensively as a disposable item or widget, at least due to relatively simplistic or efficient production techniques and/or being constructed of relatively low-cost materials. However, in other examples, the interactive card 100 may be configured to be reusable and, in such examples, may be constructed more expensively and/or more resiliently.

Finally, the interactive card 100 may form various shapes and sizes. In some examples, the interactive card 100 may form a generally rectangular shape, such as shown in FIGS. 1-5. In such examples, it may be appreciated that the interactive card 100 may define at least a first dimension D1 (e.g., a length) and a second dimension D2 (e.g., a width). In some such examples, the first dimension D1 may be longitudinal distance measuring within an inclusive range of between about 3 inches and about 10 inches.

In one specific example, the first dimension D1 may be about 6 inches. In some examples, the second dimension D2 may be a lateral distance (e.g., measured orthogonally to the first dimension D1) measuring within an inclusive range of between about 2 inches and about 8 inches. In one specific example, the second dimension D2 may measure about 4 inches. In this regard, it is further appreciated that the interactive card 100 may be highly portable and may fit, for example, in a user's clothing pocket or a small bag or purse. Thus, the interactive card 100 may be convent to bring to various events and/meetings. However, in other examples, the interactive card 100 may form a wide variety of other shapes and/or sizes, such as, but not limited to, an ellipsoidal shape, a circular shape, a triangular shape, a square shape, a pentagonal shape, a hexagonal shape, or any other polygonal shape, among others.

Additionally, in various examples, each of the plurality of removable elements 104 may further define various dimensions, such as length and width, relative to the overall dimesons of the interactive card 100 (e.g., the first dimension D1 and the second dimension D2). In some examples, one or more of the plurality of removable elements 104 may define a height, as measured parallel to second first dimension D1, within an inclusive range of about 0.5 inches and about 3 inches. In one specific example, each of the plurality of removable elements 104 may define a height of about 1 inch. In some examples, one or more of the plurality of removable elements 104 may define a width of about 2.5 inches and about 9.5 inches. Finally, In some examples, each of the plurality of removable elements 104 may span the entire width of the interactive card 100. In other examples, each of the plurality of removable elements 104 may be a distance, as measured relative to the first dimension D1, equal to an entire width of the interactive card 100.

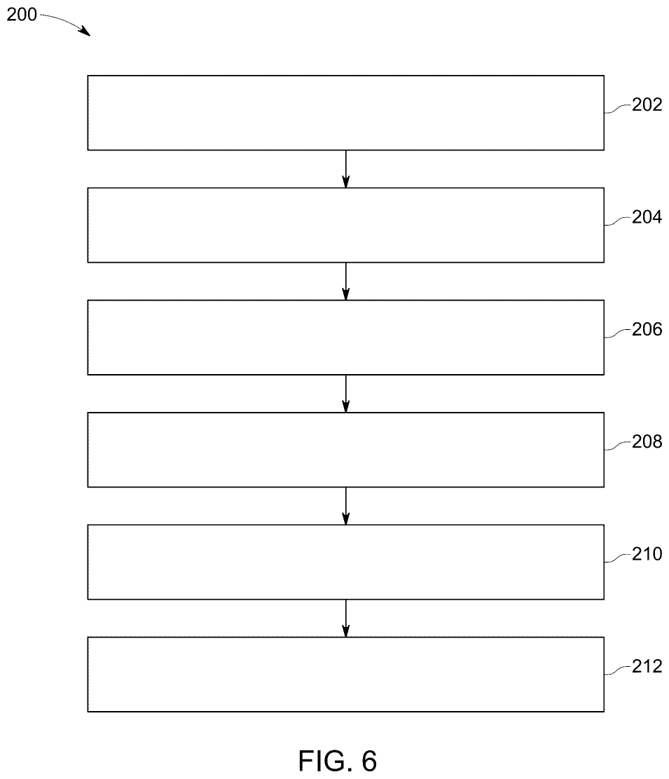

In view of all the above, it may be appreciated that the interactive card 100 may be used in various methods in a variety of applications and/or purposes. FIG. 6 illustrates a non-limiting example method 200, according to one example of the present application. In some examples, the method 200 may begin at stage 202. In some examples, stage 202 may include obtaining the interactive card 100. In some examples, obtaining the interactive card 100 may include purchasing and/or receiving, the interactive card 100. In some examples, stage 202 may further include selecting the interactive card 100 from a plurality of interactive cards, such as each sharing the same theme, category, and/or use case but including different information within each of the plurality of information zones 106. As may be appreciated, in some such examples, at least the first label element 134 may be shared between each of the plurality of interactive cards such that the cards share the same category, theme, or use case.

Next, method 200 may continue to stage 204. In some examples, stage 204 may include viewing a set of instructions for the interactive card 100. For example, a user may read, or may otherwise observe and/or mentally process, content within the instruction zone 144 to help the user understand how the interactive card 100 is intended to be used and/or physically or digitally engaged. Subsequently, at stage 206, a user may remove one of the plurality of removable elements 104 from the interactive card 100 to reveal hidden information that may be designed or otherwise configured to elicit a spoken user response, such as by providing a question or verbal action prompt to help begin meaningful conversational engagement between the user and one or more other people.

The method 200 may then continue to stage 206. In some examples, stage 206 may include vocalizing a response to the information revealed to the user during stage 204. For example, a user may first remove one or the plurality of removable elements 104 and read or view the information contained in a corresponding one of the plurality of information zones 106 there beneath. Then, a user may formulate, and speak an answer or response (e.g., an opinion and/or thought(s)) out loud such that other people and/or users may listen and engage. In some examples, during stage 206, one or more additional users of the interactive card 100 may also, and subsequently, vocalize an answer or response to the information contained in the revealed information zone, so that a meaningful exchange of ideas, thoughts, or opinions is established.

In some examples, the method 200 may subsequently proceed to stage 208. In some examples, stage 208 may include removing a plurality of additional shielding elements to reveal a plurality of additional questions or action prompts related to the category, theme, or use case of the interactive card 100. For example, after a first user has removed one of the plurality of removable elements 104 from the interactive card 100 and one, or a plurality of, users have responded to a revealed question and/or verbal action prompt in one of the plurality of information zones 106, the first user or a different second user may then remove one of the plurality of additional removable elements 104 from the interactive card 100 and vocally respond to a revealed question and or verbal action prompt.

In some examples, the method 200 may further proceed to stage 210. In some examples, stage 210 may include scanning a quick response code disposed on the interactive card 100 with a mobile device, such as to access, discover, engage with, or interact with, additional, and digital, content related to the interactive card 100. For example, by engaging with the electronic engagement zone 146, a user may be directed to mobile application or webpage that is adapted for the category, use case, intended purpose, or theme of the interactive card 100. In some examples, the information on such a webpage, or accessed in such a mobile application, may include additional questions or action prompts, example answers to questions or answer prompts, criteria or methods of evaluating the responses or answers made or given to questions or action prompts, among other information contained in the plurality of information zones 106 as previously discussed above.

In some examples, such as before or after stage 208, the method may include stage 212. In some examples, stage 212 may include selecting a second or further interactive card from a plurality of interactive cards, such as each sharing the same theme, category, and/or use case but including different information within each of the plurality of information zones 106. As may be appreciated, in some such examples, at least the first label element 134 may be shared between each of the plurality of interactive cards such that the cards share the same category, theme, or use case. However, in other examples, it is also appreciated that the second interactive card selected by a user may not share the same subcategory or subtheme, such as indicated by the second label element 138, or in further examples, may not even share the same category or them, such as indicated by the first label element 134.

In consideration of all the above, it may be readily appreciated that by combining the physical act of revealing hidden information with carefully curated content adapted to foster visual and/or verbal interaction between users, and also digital integration, the interactive card 100 is positioned at the intersection of cognitive science, psychology, and interactive design. Accordingly, based on this observation and all the above, the interactive card 100 may be utilized as a powerful tool for aiding interpersonal engagement, personal and/or emotional healing or growth, educational learning, physical fitness, and/or organizational growth or promotion, among other applications.

Additionally, the inventors have recognized that the act of uncovering hidden information provided by at least the plurality of removable elements 104, the plurality of information zones 106, and/or the electronic engagement zone 146 of the interactive card 100 may carry significant psychological benefits that make it a powerful tool for interpersonal engagement, learning, and personal growth. First, for example, the anticipation of, and/or the acts involved in, discovering hidden information may cause a neurochemical response (e.g., a dopamine release) that creates a sense of pleasure and reinforces behavior, intrinsically motivating individuals to continue the behavior which leads to such discovery.

Second, research has shown that curiosity may enhance memory retention, as when people uncover hidden information that they are curious about they may also be more likely to remember it later as the brain treats this type of discovery as inherently rewarding. Third, the act of physically revealing hidden information may give users a tangible sense of control over their learning experience. This sense of agency may be crucial for motivation and engagement, as it may allow individuals to feel that they are active participants in the discovery process rather than passive recipients of information.

Fourth, unlike presenting a relatively large amount of information all at once, which may be overwhelming to a user, revealing hidden information, as via use of the piece by piece may allow for gradual mental processing. This slower paced revelation may lead to better understanding and/or integration of complex ideas or large amounts of information. Fifth, hidden information contains an element of surprise, which may enhance attention and engagement, as novel or interesting information and/or unexpected connections revealed through the discovery process may spark creativity and lateral thinking.

Sixth, the process of revealing hidden information may help individuals to overcome confirmation bias by presenting new facts or perspectives that might challenge their preconceived notions, which may, in turn, promote more open-minded thinking and cognitive flexibility. Seventh, by strategically hiding and revealing information, complex topics may be broken down into more manageable pieces to achieve scaffolded or organized tier learning, which may help to build confidence as learners progressively master more challenging content in an ordered fashion.

Eighth, the act of uncovering hidden information may prompt individuals to reflect on their own knowledge and learning process to provide metacognitive awareness which may help to enhance overall learning strategies and self-regulated learning skills. Ninth, the excitement and satisfaction of discovery may create an emotional connection to the learning material to provide a degree of emotional engagement which may, in turn, lead to deeper processing of information and/or longer-term retention of information. Tenth, when the process of uncovering hidden information is shared with others, it may create opportunities for collaborative learning, discussion, and the exchange of ideas. This social dimension or social learning opportunity may further enhance understanding between users at least by providing multiple perspectives on discovered information.

Still further, the inventors have also recognized that research in psychology has highlighted significant cognitive, emotional, and social benefits associated with interactive discovery and structured communication provided by the interactive card 100. First, by engaging with prompts or questions, crucial communication skills such as active listening, empathy, and clear articulation of thoughts and/or feelings may be further enhanced or developed. Second, reflecting on and expressing emotions in a structured format may help to improve emotional intelligence by contributing to the development of self-awareness, emotional regulation, and improved social skills. Third, non-competitive, expressive activities may create an environment where individuals may express themselves without fear of judgment, which may help to boost self-esteem and confidence.

Fourth, engaging in reflective activities and social connection may serve as a form of mindfulness practice to help reduce anxiety and stress. Fifth, exposure to diverse viewpoints and structured communication may foster perspective-taking abilities and non-confrontational communication skills, which are important in developing and improving conflict resolution abilities. Sixth, open-ended verbal action prompts and exposure to diverse perspectives or opinions may help to stimulate creativity and promote deeper critical thinking about personal and societal issues. Seventh, and finally, shared discovery and communication experiences may help to foster a sense of connection and belonging, which is important in maintaining psychological well-being.

What is claimed is:

1. An interactive card comprising:
a plurality of information zones each including textual information;
a plurality of removable elements disposed over the plurality of information zones, wherein each of the plurality of removable elements are configured to conceal one information zone of the plurality of information zones; and
an instruction zone including a set of text-based user instructions.

2. The interactive card of claim 1, further comprising an electronic engagement zone including a quick release code configured to provide a link to digital content related to the interactive card.

3. The interactive card of claim 2, wherein each of the plurality of removable elements comprises a pull-tab.

4. The interactive card of claim 3, wherein each the plurality of information zones and each of the plurality of removable elements are located on a first side of the interactive card, and wherein the instruction zone and the electronic engagement zone are located on a second side of the interactive card.

5. The interactive card of claim 4, wherein the textual information of each of the plurality of information zones comprises a question designed to elicit a spoken response from a user.

6. The interactive card of claim 5, wherein the first side of the interactive card includes a category label configured to convey a category for the interactive card, and wherein the question is related to the category for the interactive card.

7. The interactive card of claim 6, wherein the first side of the interactive card further includes a subcategory label configured to convey a sub-category for the interactive card.

8. The interactive card of claim 7, wherein the plurality of information zones includes at least six information zones, and wherein the plurality of removable elements includes at least six shielding elements.

9. The interactive card of claim 8, wherein the interactive card is made from a fibrous material.

10. The interactive card of claim 9, wherein the plurality of information zones are printed on a first material layer and the plurality of removable elements comprises a portion of a second material layer that is bonded to and entirely overlaps the first material layer.

11. A method of using an interactive card, the method comprising:
obtaining the interactive card;
removing a shielding element from the interactive card to reveal textual information configured to elicit a spoken user response;
vocalizing an audible response to the textual information; and
scanning a quick response code disposed on the interactive card with a mobile device to access digital content related to the interactive card.

12. The method of claim 11, wherein removing the shielding element includes viewing a front surface of the interactive card, and wherein scanning the quick response code includes viewing a back surface of the interactive card.

13. The method of claim 12, wherein viewing the back surface of the interactive card further includes reading a set of user instructions for the interactive card.

14. The method of claim 11, wherein removing the shielding element comprises pulling a pull-tab.

15. The method of claim 14, wherein the textual information designed to elicit a spoken user response comprises a question related to a category of the interactive card.

16. The method of claim 15, wherein the method includes removing a plurality of additional shielding elements from the interactive card to reveal a plurality of additional questions related to the category of the interactive card.

17. The method of claim 16, wherein obtaining the interactive card includes selecting the interactive card from a plurality of interactive cards each having the same category of the interactive card.

18. A method of manufacturing an interactive card, the method comprising:
disposing a plurality of questions configured to elicit a spoken user response about a first side of a base of the interactive card;
disposing a set of user instructions about a second side of the base;
disposing a quick response code about the second side of the base;
disposing a plurality of removable shielding elements about the first side of the base to conceal a plurality of questions designed to elicit a spoken user response;
disposing a category label configured to convey a category of the interactive card about the first side of the base; and
disposing a subcategory label configured to convey a subcategory of the interactive card about the first side of the base.

19. The method of claim 18, wherein disposing the plurality of questions, the quick response code, and the set of user instructions about the second side of the base includes printing the plurality of questions, the quick response code, and the set of user instructions directly on an outer surface of the base.

20. The method of claim 18, disposing a plurality of questions configured to elicit a spoken user response about the first side of the base includes printing the plurality of questions on a front surface of the base; and wherein disposing the plurality of removable shielding elements about the first side of the base includes adhering a second material layer over an entire first material layer of the base.
